(19) United States
(12) Patent Application Publication
(10) Pub. No.: US 2023/0259010 A1
(43) Pub. Date: Aug. 17, 2023

(54) HANDHELD GIMBAL AND FOLDING STRUCTURE

(71) Applicant: SZ DJI TECHNOLOGY CO., LTD., Shenzhen (CN)

(72) Inventors: Tianfei ZHAO, Shenzhen (CN); Shiqiang ZHOU, Shenzhen (CN)

(21) Appl. No.: 18/301,702

(22) Filed: Apr. 17, 2023

Related U.S. Application Data
(63) Continuation of application No. PCT/CN2020/141607, filed on Dec. 30, 2020.

(51) Int. Cl. G03B 17/56; F16M 13/04; F16M 11/18; F16M 11/10; F16M 11/04; F16M 11/20; H04M 1/04

(52) U.S. Cl. CPC G03B 17/561; F16M 11/18; F16M 11/041; F16M 11/105; F16M 11/2064; F16M 13/04; G03B 17/563; H04M 1/04; F16M 2200/021

(57) ABSTRACT

A handheld gimbal includes a handle and a gimbal. The gimbal is connected to the handle and includes at least two shaft assemblies. The at least two shaft assemblies are rotatably connected to each other. Each of the at least two shaft assemblies includes a motor. The motors of the at least two shaft assemblies are arranged one over another along a same straight line when the gimbal is in a folded state. The motors of the at least two shaft assemblies are arranged separately when the gimbal is in an unfolded state.

### CROSS-REFERENCE TO RELATED APPLICATION

This application is a continuation of International Application No. PCT/CN2020/141607, filed Dec. 30, 2020, the entire content of which is incorporated herein by reference.

### TECHNICAL FIELD

The present disclosure relates to the gimbal technology field and, more particularly, to a handheld gimbal and a folding structure.

### BACKGROUND

Nowadays, a photography device is widely used to photograph a picture or record a video. When a user holds the photography device to take a picture, the picture is blurred if the hands of the user shake. Generally, the photography device is mounted on a handheld gimbal. The handheld gimbal is configured to stabilize the photography device or adjust the photography angle of the photography device to obtain a sharp picture or video. However, in the related art, the volume of the handheld gimbal is big, and the handheld gimbal is not easy to be stored or transported, which affects user experience.

### SUMMARY

In accordance with the disclosure, there is provided a handheld gimbal, including a handle and a gimbal. The gimbal is connected to the handle and includes at least two shaft assemblies. The at least two shaft assemblies are rotatably connected to each other. Each of the at least two shaft assemblies includes a motor. The motors of the at least two shaft assemblies are arranged one over another along a same straight line when the gimbal is in a folded state. The motors of the at least two shaft assemblies are arranged separately when the gimbal is in an unfolded state.

Also in accordance with the disclosure, there is provided a handheld gimbal, including a handle and a gimbal. The gimbal is connected to the handle and includes at least two shaft assemblies. The at least two shaft assemblies are rotatably connected to each other. Each of the at least two shaft assemblies includes a motor including a motor rotation shaft. When the gimbal is in a folded state, axes of the motor rotation shafts of the at least two shaft assemblies are parallel to each other.

Also in accordance with the disclosure, there is provided a handheld gimbal, including a handle and a gimbal. The gimbal is connected to the handle and includes at least two shaft assemblies. The at least two shaft assemblies are rotatably connected to each other. Each of the at least two shaft assemblies includes a motor and a shaft arm connected to the motor. When the gimbal is in a folded state, the shaft arms of the at least two shaft assemblies are located on a same side of the handle and locked together with each other.

### BRIEF DESCRIPTION OF THE DRAWINGS

FIG. 1 is a schematic perspective structural diagram showing a handheld gimbal in a folded state consistent with an embodiment of the present disclosure.

FIG. 2 is a schematic perspective structural diagram showing the handheld gimbal in an intermediate state consistent with an embodiment of the present disclosure.

FIG. 3 is another schematic perspective structural diagram showing the handheld gimbal in an unfolded state consistent with an embodiment of the present disclosure.

FIG. 4 is another schematic perspective structural diagram showing the handheld gimbal in a folded state consistent with an embodiment of the present disclosure.

FIG. 5 is another schematic perspective structural diagram showing the handheld gimbal in an unfolded state consistent with an embodiment of the present disclosure.

FIG. 6 is another schematic perspective structural diagram of the handheld gimbal consistent with an embodiment of the present disclosure.

Reference numerals

| | | | | | |
|---|---|---|---|---|---|
| 100 | Handheld gimbal | 10 | Handle | 12 | Accommodation groove |
| 122 | Position-limiting block | 14 | Controller | 20 | Gimbal |
| 22 | First shaft assembly | 222 | First shaft arm | 222 | First sub-arm |
| 224 | Second sub-arm | 2226 | Rotation shaft assembly | | |
| 224 | First motor | 24 | Second shaft assembly | | |
| 242 | Second shaft arm | 244 | Second motor | 26 | Third assembly |
| 262 | Third motor | 30 | Fixation mechanism | | |
| 40 | Load connector | 200 | Load | | |

### DETAILED DESCRIPTION OF THE EMBODIMENTS

Embodiments of the present disclosure are described in detail. Examples of embodiments are shown in the accompanying drawings. A same or similar character may be used to represent a same or similar element or elements having a same or similar function. Embodiments described refer to the accompanying drawings are exemplary and only used to explain the present disclosure and should not be understood as a limitation of the present disclosure.

In the description of embodiments of the present disclosure, orientational or positional relationships indicated by terms such as “center,” “longitudinal,” “landscape,” “length,” “width,” “thickness,” “upper,” “lower,” “front,” “back,” “left,” “right,” “vertical,” “horizontal,” “top,” “bottom,” “inner,” “outer,” “clockwise,” “counterclockwise” are based on the orientational or positional relationship shown in the drawings. The terms are only used to facilitate the description of embodiments of the present disclosure and simplify the description, rather than indicating or implying that the device or element referred to must have a specific orientation and be constructed and operated in a specific orientation. Therefore, the terms cannot be understood as a limitation to the present disclosure. In addition, the terms “first” and “second” are only used for descriptive purposes and cannot be understood as indicating or implying relative importance or implicitly indicating the number of indicated technical features. Thus, a feature as associated with “first” and “second” may explicitly or implicitly include one or more of the features. In the description of the present disclosure, “a plurality of” means two or more than two, unless otherwise specifically defined.

In the description of embodiments of the present disclosure, the terms “mount,” “connection,” and “coupling” should be understood in a broad sense. For example, the terms may indicate a fixed connection, a detachable connection, an integral connection, a mechanical connection, an electrical connection, a communication, a direct connection, an indirect connection through an intermediary, internal communication of two components, or an interaction relationship of two components. Those of ordinary skill in the art should understand the specific meanings of the above terms in embodiments of the present disclosure according to specific situations.

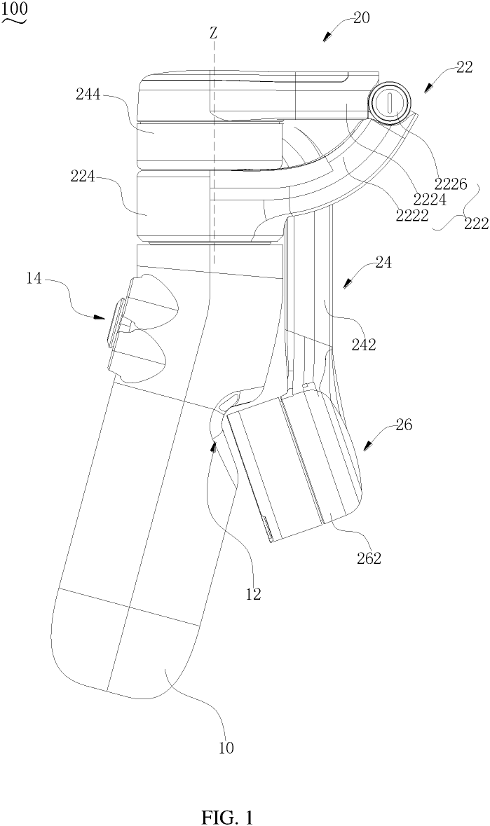

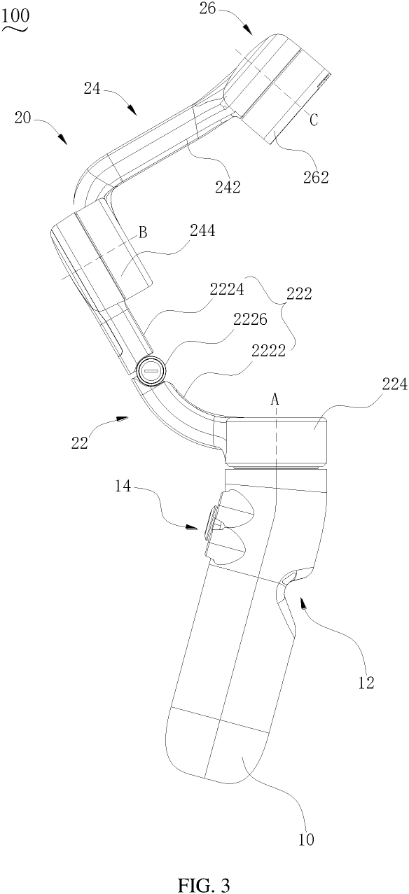

Refer to FIG. 1 to FIG. 3, a handheld gimbal 100 of embodiments of the present disclosure includes a handle 10 and a gimbal 20. The gimbal 20 is connected to the handle 10. The gimbal 20 can include at least two shaft assemblies. The two shaft assemblies can be rotatably connected. A shaft assembly can include a motor. The gimbal 20 can be switched between a folded state and an unfolded state. In the folded state, motors of the at least two shaft assemblies can be stacked one over another along a same straight line Z. In the unfolded state, the motors of the at least two shaft assemblies can be arranged separately.

Thus, when the handheld gimbal 100 is in the folded state, the motors of the at least two shaft assemblies can be stacked one over another along the same straight line Z. Thus, the space occupied by the handheld gimbal 100 can be small in the folded state, and the handheld gimbal 100 can be easy to store and transport, which improves user experience.

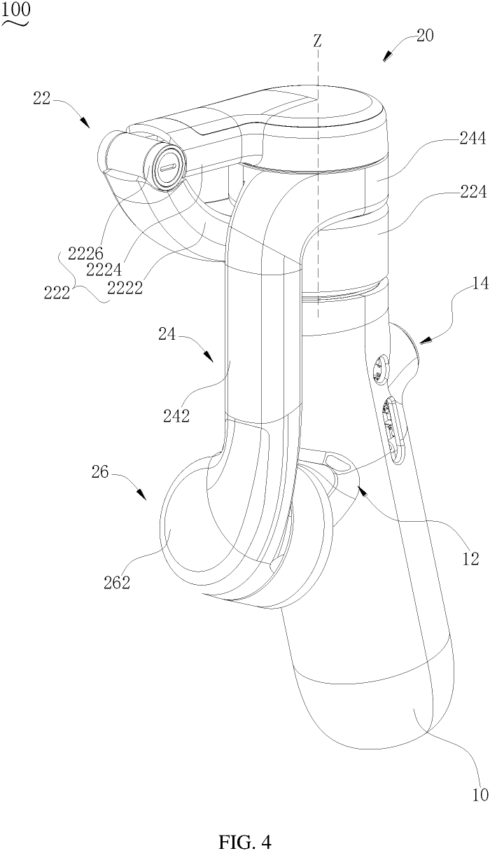

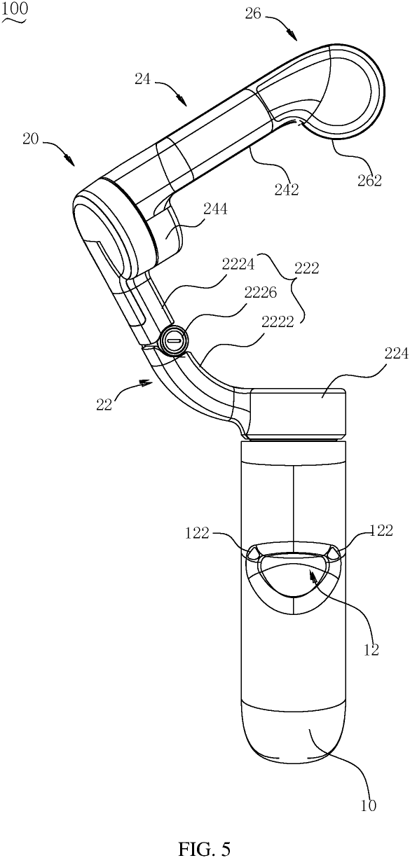

Refer to FIG. 1 to FIG. 5, the handheld gimbal 100 includes the handle 10, the gimbal 20, and a fixation mechanism 30. The gimbal 20 is connected to the handle 10.

The gimbal 20 can include the at least two shaft assemblies. The at least two shaft assemblies can be rotatably connected. The motors of the at least two shaft assemblies can include motor rotation shafts. In the folded state, axes of the motor rotation shafts of the at least two shaft assemblies can be parallel to each other. Thus, the motors of the at least two shaft assemblies can be closer in space, which can reduce the space occupied by the handheld gimbal 100 in the folded state. Further, when the axes of the motor rotation shafts of the at least two shaft assemblies are coincident with the same straight line Z, the motors of the at least two shaft assemblies can have a distance in space to be closest. Thus, the space occupied by the handheld gimbal 100 can be small in the folded state, and the handheld gimbal 100 can be easy to store and transport.

Refer to FIG. 1 to FIG. 5, in some embodiments, the at least two shaft assemblies include a first shaft assembly 22, a second shaft assembly 24, and a third assembly 26. The first shaft assembly 22, the second shaft assembly 24, and the third assembly 26 can be rotatably connected. The first shaft assembly 22 includes a first shaft arm 222 and a first motor 224 that can be folded and unfolded. The second shaft assembly 24 includes a second shaft arm 242 and a second motor 244.

In some embodiments, the third assembly 26 can include at least one of a third motor 262, a load connector 40, or a photographing device. In some embodiments, the third assembly 26 can include the third motor 262. The third motor 262 can be connected to the second shaft arm 242. In some other embodiments, the third assembly 26 can include the third motor 262 and the load connector 40. The third motor 262 can be connected to the second shaft arm 242 and the load connector 40. In some other embodiments, the third assembly 26 can include the third motor 262 and the photographing device (not shown). The photographing device can be connected to the second shaft arm 242. In some other embodiments, the third assembly 26 can include the load connector 40. The load connector 40 can be connected to the second shaft arm 242. In some other embodiments, the third assembly 26 can include the photographing device. The photographing device can be connected to the second shaft arm 242.

In some embodiments, the third assembly 26 can be a third shaft assembly 26. The third shaft assembly 26 can include the third motor 262. The first shaft assembly 22 and the second shaft assembly 24 can be rotatably connected. When the gimbal 20 is in the folded state and an intermediate state, the first motor 224 and the second motor 244 can be stacked one over another along the same straight line Z. When the gimbal 20 is in the unfolded state, the first motor 224 and the second motor 244 can be arranged separately. Thus, the handheld gimbal 100 can be switched between the folded state and the unfolded state. Therefore, the space occupied by the handheld gimbal 100 can be small in the folded state, and the handheld gimbal 100 can be easy to store and transport, which improves the user experience.

The first motor 224 can include a first motor rotation shaft. The second motor 244 can include a second motor rotation shaft. In the folded state and the intermediate state, axis A of the first motor rotation shaft and axis B of the second motor rotation shaft can be parallel to each other. Thus, the distance between the first motor 224 and the second motor 244 can be closer in space, which can reduce the space occupied by the handheld gimbal 100 in the folded state. Further, when axis A of the first motor rotation shaft and axis B of the second motor rotation shaft coincide with the same straight line Z, the distance between the first motor 224 and the second motor 244 can be the closest in space. Thus, the space occupied by the handheld gimbal 100 can be smaller in the folded state, and the handheld gimbal 100 can be easy to store and transport.

The first motor 224 can include a stator and a rotor. The second motor 244 can include a stator and a rotor. When the gimbal 20 is in the folded state and the intermediate state, the handheld gimbal 100 can have one of the following structures. In some embodiments, the stator of the second motor 244, the rotor of the second motor 244, the stator of the first motor 224, and the rotor of the first motor 224 can be arranged from top to bottom along the same straight line Z. In some other embodiments, the rotor of the second motor 244, the stator of the second motor 244, the stator of the first motor 224, and the rotor of the first motor 224 can be arranged from top to bottom along the same straight line Z. In some other embodiments, the stator of the second motor 244, the rotor of the second motor 244, the rotor of the first motor 224, and the stator of the first motor 224 can be arranged from top to bottom along the same straight line Z. In some other embodiments, the rotor of the second motor 244, the stator of the second motor 244, the rotor of the first motor 224, and the stator of the first motor 224 can be arranged along the same straight line Z from top to bottom.

In some embodiments, the first motor 224 can be a yaw motor, and correspondingly, the first motor rotation shaft can be a yaw motor rotation shaft. The second motor 244 can be a pitch motor, and correspondingly, the second motor rotation shaft can be a pitch motor rotation shaft. The third motor 262 can be a roll motor, and correspondingly, the third motor rotation shaft can be a roll motor rotation shaft.

In some embodiments, the axes of the first motor rotation shaft, the second motor rotation shaft, and the third motor rotation shaft can be non-orthogonal to each other. In some other embodiments, the first motor rotation shaft, the second motor rotation shaft, and the third motor rotation shaft can be arranged to any suitable arrangement according to an actual application scenario. For example, axis A of the first motor rotation shaft can be substantially perpendicular to axis B of the second motor rotation shaft, and axis A of the first motor rotation shaft can be substantially perpendicular to axis C of the third motor rotation shaft. Being substantially perpendicular can indicate that an included angle between axes of the two motor rotation shafts ranges between 85° and 95°. An included angle between axis B of the second motor rotation shaft and axis C of the third motor rotation shaft can be an acute angle, for example, 50°.

The handle 10 can be roughly in an inclined rod shape and be configured for a user to hold and control the handheld gimbal 100. An accommodation groove 12 can be arranged on a side of the handle 10. When the gimbal 20 is in the folded state and the intermediate state, the third motor 262 can be at least partially located in the accommodation groove 12. The accommodation groove 12 can limit the rotation of the third motor 262 along a circumferential direction of the handle 10. For example, the accommodation groove 12 can include at least two position-limiting blocks 122 symmetrically arranged in a horizontal direction. The two position-limiting blocks 122 can be configured to abut against the third motor 262 to prevent the second shaft arm from swinging back and forth relative to the handle 10 when the third motor 262 is partially located in the accommodation groove 12, which improves the stability of the handheld gimbal 100 in the folded state. When the gimbal 20 is in the unfolded state, the third motor 262 can be located outside the accommodation groove 12. The handle 10 can further include a controller 14. The controller 14 can be arranged on a side opposite to the accommodating groove 12. The gimbal 20 can be controlled by the controller 14 to adjust positions and orientations of the first motor 224 and the second motor 244. Thus, functions such as stabilization or attitude maintaining of the gimbal 20 can be implemented. In some other embodiments, the handle can be in a vertical rod shape. The accommodation groove may not be provided on the side of the handle. When the gimbal 20 is in the folded state and the intermediate state, the third motor 262 can abut against the side of the handle. The side of the handle can restrict the rotation of the third motor 262 along the circumferential direction of the handle 10.

The first motor 224 can be mounted at a top of the handle 10. That is, the gimbal 20 can be connected to the handle 10 through the first motor 224.

The first shaft arm 222 can be connected to the first motor 224 and the second motor 244. When the gimbal 20 is in the folded state and the unfolded state, the first shaft arm 222 can be folded, and when the gimbal 20 is in the unfolded state, the first shaft arm 222 can be unfolded.

In some embodiments, the first shaft arm 222 can connect the stator of the first motor 224 and the stator of the second motor 244. In some other embodiments, the first shaft arm 222 can be connected to the rotor of the first motor 224 and the stator of the second motor 244. In some other embodiments, the first shaft arm 222 can be connected to the stator of the first motor 224 and the rotor of the second motor 244. In some other embodiments, the first shaft arm 222 can be connected to the rotor of the first motor 224 and the rotor of the second motor 244, which is not limited here. When the first shaft arm 222 is connected to the stator of the first motor 224, the rotor of the first motor 224 can be mounted on the top of the handle 10. When the first shaft arm 222 is connected to the rotor of the first motor 224, the stator of the first motor 224 can be mounted on the top of the handle 10. Thus, the stator of the first motor 224 can rotate relative to the rotor of the first motor 224 and can drive the gimbal 20 to rotate around the first motor rotation shaft.

The first shaft arm 222 can include a first sub-arm 2222, a second sub-arm 2224, and a rotation shaft assembly 2226. The first sub-arm 2222 can be connected to the first motor 224 and the rotation shaft assembly 2226. The second sub-arm 2224 can be connected to the second motor 244 and the rotation shaft assembly 2226. The rotation shaft assembly 2226 can be configured to be connected to the first sub-arm 2222 and the second sub-arm 2224 to be hinged to the first motor 224 and the second motor 244. Thus, the spatial positions of the first motor 224 and the second motor 244 can be changed by folding and unfolding the first shaft arm 222 to change the space occupied by the handheld gimbal 100. When the first shaft arm 222 is folded, the spatial positions of the first motor 224 and the second motor 244 can be close. Thus, the space occupied by the handheld gimbal 100 can be small, and the handheld gimbal 100 can be easy to store and transport. When the first shaft arm 222 is unfolded, the spatial positions of the first motor 224 and the second motor 244 can be far away. Thus, the handheld gimbal 100 can work normally.

In some embodiments, the first sub-arm 2222 can be connected to the stator or rotor of the first motor 224. When the first sub-arm 2222 is connected to the stator of the first motor 224, the rotor of the first motor 224 can be connected to the top of the handle 10. When the first sub-arm 2222 is connected to the rotor of the first motor 224, the stator of the first motor 224 can be connected to the top of the handle 10. Thus, when the stator of the first motor 224 rotates relative to the rotor of the first motor 224, the stator of the first motor 224 can drive the first shaft arm 222 to rotate around the first motor rotation shaft. Similarly, the second sub-arm 2224 can be connected to the stator or the rotor of the second motor 244.

Further, in some embodiments, one of the first sub-arm 2222 and the second sub-arm 2224 can be curved, and the other one of the first sub-arm 2222 and the second sub-arm 2224 can be straight. In some other embodiments, both the first sub-arm 2222 and the second sub-arm 2224 can be curved. When the gimbal 20 is in the folded state, accommodation space can be formed between the first sub-arm 2222 and the second sub-arm 2224. The stator or rotor of the second motor 244 can be located in the accommodation space. In embodiments of FIG. 1, the first sub-arm 2222 is curved, and the second sub-arm 2224 is straight.

The rotation shaft assembly 2226 can include a lock mechanism (not shown) and a rotation shaft (not shown). The lock mechanism can be arranged between the first sub-arm 2222 and the second sub-arm 2224 and configured to lock a relative rotation between the first sub-arm 2222 and the second sub-arm 2224 to lock the gimbal 20 in the unfolded state or folded state. The rotation shaft can pass through at least one of the first sub-arm 2222 or the second sub-arm 2224 to be hinged to the first motor 224 and the second motor 244.

The lock mechanism can lock the relative position between the first sub-arm 2222 and the second sub-arm 2224 to cause the gimbal 20 to be maintained stably in the unfolded or folded state. When the lock mechanism is locked, the first sub-arm 2222 and the second sub-arm 2224 cannot rotate relative to each other. When the lock mechanism is unlocked, the first sub-arm 2222 and the second sub-arm 2224 can rotate relative to each other. When the gimbal 20 is in the unfolded state, the lock mechanism can be locked. The first sub-arm 2222 and the second sub-arm 2224 cannot rotate relative to each other, and the gimbal 20 can work normally. By applying a torque greater than a torque of the lock mechanism, the lock mechanism can be unlocked, and the locking between the first sub-arm 2222 and the second sub-arm 2224 can be released. Thus, the first sub-arm 2222 and the second sub-arm 2224 can rotate relative to each other. When the first sub-arm 2222 and the second sub-arm 2224 rotate to be in the folded state, the lock mechanism can be locked again. The first sub-arm 2222 and the second sub-arm 2224 cannot rotate relative to each other. A volume of the gimbal 20 can be minimized, and the handheld gimbal 100 can be easy to store and transport. The lock mechanism can be any suitable lock structure, as long as the relative rotation between the first sub-arm 2222 and the second sub-arm 2224 can be locked. For example, the lock mechanism can include at least one of baffle lock structure, eccentric lock structure, four-bar mechanism lock structure, or snap lock structure.

For example, the lock mechanism can include a first position-limiting hole, a second position-limiting hole, a spring, and a positioning ball. The first position-limiting hole can be arranged at the first sub-arm. The second position-limiting hole can be arranged at the second sub-arm at a position corresponding to the first position-limiting hole. The spring and the positioning ball can be arranged in the first position-limiting hole. One end of the spring can abut against a bottom wall of the first position-limiting hole, and the other end of the spring can abut against the positioning ball. The positioning ball can be partially accommodated in the second position-limiting hole under the action of the spring to lock the relative rotation between the first sub-arm and the second sub-arm. When the first sub-arm rotates relative to the second sub-arm under an external force, the positioning ball can compress the spring. Thus, the positioning ball can be separated from the second position-limiting hole. Then, the first sub-arm and the second sub-arm can rotate relative to each other. Thus, the locking and unlocking of the first sub-arm and the second sub-arm can be realized.

In some other embodiments, the first sub-arm and the second sub-arm can be automatically locked together by the torque of the motor. Thus, the first shaft arm can be kept in the folded state. Similarly, when the handheld gimbal is switched between the folded state, the intermediate state, and the unfolded state, the handheld gimbal can be switched manually, the handheld gimbal can be driven by motor to be switched.

The second shaft arm 242 can be connected to the second motor 244 and the third motor 262. When the gimbal 20 is in the folded state, the first shaft arm 222 and the second shaft arm 242 can be located on a same side of the handle 10. The first shaft arm 222 and the second shaft arm 242 can be locked together through a fixation mechanism 30 to better maintain the folded state, which prevents the at least two shaft assemblies from rotating relative to each other and the folded state from being released during storage and transport processes. The handheld gimbal 100 can be inconvenient to be stored or can be damaged during the transport process if the at least two shaft assemblies rotate relative to each other and the folded state is released. When the gimbal 20 is in the intermediate state, the first shaft arm 222 and the second shaft arm 242 can be on two opposite sides of the handle 10. At least one of the first motor 224 or the second motor 244 can rotate to cause the first shaft arm 22 and the second shaft arm 242 to be switched between being on a same side of the handle 10 and on the opposite sides of the handle 10. Thus, the gimbal 20 can be switched between the folded state and the intermediate state. When the gimbal 20 is in the intermediate state, by rotating the first shaft arm 222 around axis A of the first motor rotation shaft more than 90°, the second shaft arm 242 can be limited from being unfolded. For example, when the gimbal 20 is in the intermediate state, the included angle between the first shaft arm 222 and the second shaft arm 242 can be 180°. By rotating the first shaft arm 222 around axis A of the first motor rotation shaft for 100°, the included angle between the first shaft arm 222 and the second shaft arm 242 can be reduced to 80°. Thus, the gimbal 20 can be in a state between the folded state and the intermediate state. The first shaft arm 222 can limit the second shaft arm 242 from being unfolded.

Further, the fixation mechanism 30 can be fixedly connected to shaft arms of the at least two shaft assembly in one manner of magnetic attraction, locking, snapping, interference fit, screw connection, and bonding. Thus, when the gimbal 20 is in the folded state, the at least two shaft assemblies can be locked with each other through the fixation mechanism 30. Therefore, the folded state can be better maintained to prevent the relative rotation between the at least two shaft assemblies and the folded state from being released during the storage and transport processes to cause inconvenient storage of the handheld gimbal 100 and damage to the handheld gimbal 100 during the transport process.

In some embodiments, the fixation mechanism 30 can be fixedly connected to the shaft arms of the at least two shaft assemblies through the magnetic attraction. The fixation mechanism 30 can include magnet members (not shown). The magnet members can be arranged at the first shaft arm 222 and the second shaft arm 242. When the gimbal 20 is in the folded state, the first shaft arm 222 and the second shaft arm 242 can be located on a same side of the handle 10. The first shaft arm 222 and the second shaft arm 242 can be locked with each other in the manner of the magnetic attraction through the magnet members. Thus, the folded state can be better maintained. In some embodiments, a magnet member can include a magnet and a material that can be attracted by the magnet. For example, the magnet members of the first shaft arm 222 and the second shaft arm 242 can be magnets. When a distance between the first shaft arm 222 and the second shaft arm 242 reaches a certain threshold, the magnets of the first shaft arm 222 and the second shaft arm 242 can attract each other to lock the first shaft arm 222 and the second shaft arm 242. In some other embodiments, one magnet member of the first shaft arm 222 and the second shaft arm 242 can be a magnet, the other magnet member of the first shaft arm 222 and the second shaft arm 242 can be the material that can be attracted by the magnet. When the distance between the first shaft arm 222 and the second shaft arm 242 reaches a certain threshold, the magnet of the first shaft arm 222 and the second shaft arm 242 can attract the material that can be attracted by the magnet. Thus, the first shaft arm 222 and the second shaft arm 242 can be locked.

In some other embodiments, the fixation mechanism 30 can be fixedly connected to the shaft arms of the at least two shaft assemblies in the manner of interference fit. The fixation mechanism 30 can include a protrusion (not shown) and a groove (not shown). One of the protrusion and the groove can be arranged at the first shaft arm 222, and the other one of the protrusion and the groove can be arranged at the second shaft arm 242. A size of the protrusion can be slightly larger than a size of the groove. Thus, the protrusion can be better fixed in the groove. Therefore, when the gimbal 20 is in the folded state, the first shaft arm 222 and the second shaft arm 242 can be located on the same side of the handle 10, and the first shaft arm 222 and the second shaft arm 242 can be locked to each other in the manner of interference fit to better maintain the folded state.

In some other embodiments, the fixation mechanism 30 can be fixedly connected to the shaft arms of the at least two shaft assemblies in the manner of bonding. The fixation mechanism 30 can include a Velcro (not shown). The Velcro can include a hook surface and a loop surface. One of the hook surface and the loop surface can be arranged at the first shaft arm 222, and the other one of the hook surface and the loop surface can be arranged at the second shaft arm 242. The hook surface can include hooks, and the loop surface can include fibers. The hooks can be bonded with the fibers. Thus, when the gimbal 20 is in the folded state, the first shaft arm 222 and the second shaft arm 242 can be located on the same side of the handle 10, and the first shaft arm 222 and the second shaft arm 242 can be locked together through the bonding to better maintain the folded state.

In some other embodiments, the first shaft arm and the second shaft arm can be automatically locked together by the torque of the motor to maintain the handheld gimbal to be in the folded state. Similarly, when the handheld gimbal is switched between the folded state, the intermediate state, and the unfolded state, the handheld gimbal can be switched manually, or the handheld gimbal can be driven by the motor to be switched.

When the gimbal 20 is in the folded state, an unfolding direction of the second sub-arm 2224 can be opposite to an unfolding direction of the second shaft arm 242. Refer to FIG. 1, when the gimbal 20 is in the folded state, the unfolding indicates that the gimbal 20 is switched from the folded state to the intermediate state. Since the first shaft arm 222 and the second shaft arm 242 are locked together by the fixation mechanism 30, if the gimbal 20 needs to be switched from the folded state to the intermediate state, a force may need to be applied to unlock the fixation mechanism 30. Thus, the first shaft arm 222 and the second shaft arm 242 can be separated. The gimbal 20 can be switched from the folded state to the intermediate state. For example, when the second sub-arm 2224 rotates relative to the second shaft arm 242 along axis B of the second motor rotation shaft clockwise, or the second shaft arm 242 rotate relative to the second sub-arm 2224 along axis B of the second motor rotation shaft counterclockwise, the fixation mechanism 30 can be unlocked, and the gimbal 20 can be switched from the folded state to the intermediate state.

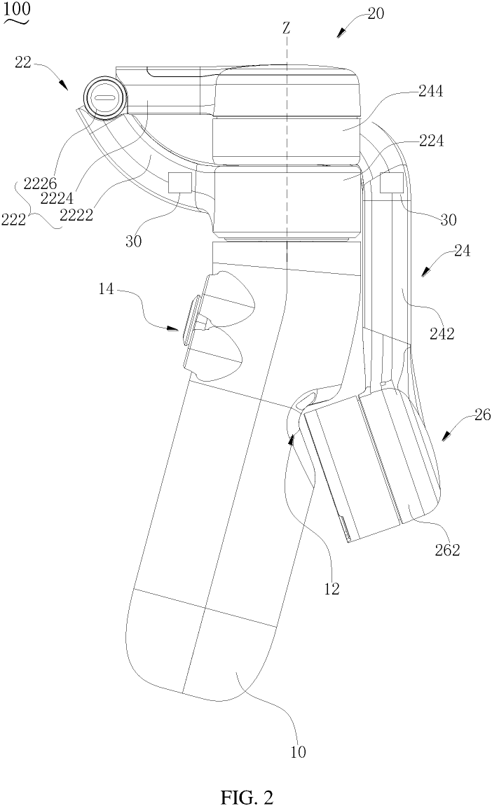

When the gimbal 20 is in the intermediate state, the unfolding direction of the second sub-arm 2224 can be the same as the unfolding direction of the second shaft arm 242. Refer to FIG. 2, when the gimbal 20 is in the intermediate state, the unfolding indicates that the gimbal 20 is switched from the intermediate state to the unfolded state. Since the first shaft arm 222 and the second shaft arm 242 are located on two opposite sides of the handle 10, if the gimbal 20 needs to be switched from the intermediate state to the unfolded state, the force may need o be applied to cause the second sub-arm 2224 to rotate relative to the rotation shaft assembly 2226 counterclockwise. Thus, the second sub-arm 2224 can drive the second shaft arm 242 through the second motor 244 to rotate in the same direction. The gimbal 20 can be switched from the intermediate state to the unfolded state.

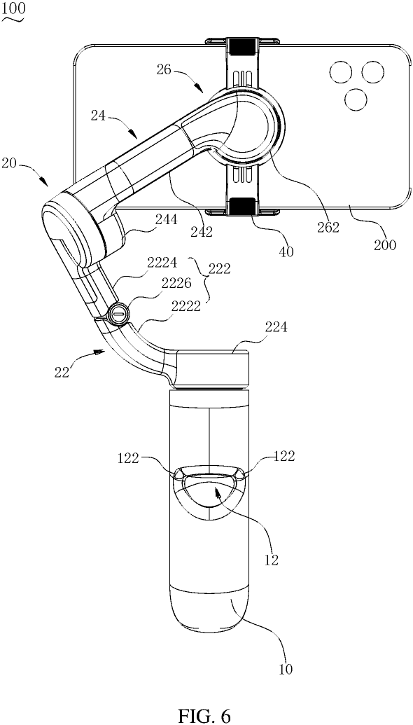

In some other embodiments, the third assembly 26 can include the third motor 262 and the load connector 40. The third motor 262 can be connected to the second shaft arm 242 and the load connector 40. That is, the handheld gimbal 100 can include the handle 10, the first shaft arm 222, the first motor 224, the second shaft arm 242, the second motor 244, the third motor 262, the fixation mechanism 30, and the load connector 40. The load connector 40 can be connected to the third motor 262. When the gimbal 20 is in the folded state and the intermediate state, the first shaft arm 222 can be folded, and the load connector 40 can be at least partially located in the accommodation groove 12. The accommodation groove 12 can limit the load connector 40 from rotating along the circumferential direction of the handle 10. When the gimbal 20 is in the unfolded state, the first shaft arm 222 can be unfolded, and the load connector 40 can be located outside the accommodation groove 12. In some embodiments, the load connector 40 can include a magnet member or a clamp member. The load connector 40 can carry the load 200 at the handheld gimbal 100 through the magnet member or the clamp member. By adjusting the position and orientation of the load 200, the handheld gimbal 100 can meet operation requirements of various scenarios. The load 200 can include one of an imaging device, a mobile terminal, and a sensor. The imaging device can include an image acquisition device such as a video camera, a camera, an ultrasonic imaging device, an infrared imaging device, and an imaging lens. The mobile terminal can include a mobile phone and a tablet computer. The sensor can include an attitude sensor, such as an angle sensor and an acceleration sensor. The imaging device can also include some mobile terminals, for example, the imaging device can include a mobile phone and a tablet computer with video recording and photographing functions. The mobile terminal can also include some imaging devices. In some embodiments shown in FIG. 6, the load 200 is a mobile phone. The first motor 224 is the yaw motor, the second motor 244 is the pitch motor, and the third motor 262 is the roll motor. The first motor 224 can control an attitude of the mobile phone in a yaw direction, the second motor 244 can control an attitude of the mobile phone in a pitch direction, and the third motor 262 can control an attitude of the mobile phone in a roll direction. Thus, the handheld gimbal 100 can realize three-axis stabilization and attitude control for the mobile phone to maintain the mobile phone in a good attitude.

In some other embodiments, the third assembly 26 can include the third motor 262 and a photographing device (not shown). The photographing device can be connected to the second shaft arm 242. That is, the handheld gimbal 100 can include the handle 10, the first shaft arm 222, the first motor 224, the second shaft arm 242, the second motor 244, the third motor 262, the fixation mechanism 30, and the photographing device. The photographing device can be connected to the third motor 262. When the gimbal 20 is in the folded state and the intermediate state, the first shaft arm 222 can be folded. The photographing device can be at least partially located in the accommodation groove 12. The accommodation groove 12 can restrict the photographing device from rotating in the circumferential direction of the handle 10. When the gimbal 20 is in the unfolded state, the first shaft arm 222 can be unfolded, and the photographing device can be located outside the accommodation groove 12. In some embodiments, the photographing device can be a camera.

In some other embodiments, the third assembly 26 can include the load connector 40. The load connector 40 can be connected to the second shaft arm 242. That is, the handheld gimbal 100 can include the handle 10, the first shaft arm 222, the first motor 224, the second shaft arm 242, the second motor 244, the fixation mechanism 30, and the load connector 40. The second shaft arm 242 can be connected to the second motor 244 and the load connector 40. When the gimbal 20 is in the folded state and the intermediate state, the first shaft arm 222 can be folded. The load connector 40 can be at least partially located in the accommodation groove 12. The accommodation groove 12 can restrict the load connector 40 from rotating along the circumferential direction of the handle 10. When the gimbal 20 is in the unfolded state, the first shaft arm 222 can be unfolded, and the load connector 40 can be located outside the accommodation groove 12. In some embodiments, the load connector 40 can include a magnet member or a clamp member.

In some other embodiments, the third assembly 26 can include the photographing device. The photographing device can be connected to the second shaft arm 242. That is, the handheld gimbal 100 can include the handle 10, the first shaft arm 222, the first motor 224, the second shaft arm 242, the second motor 244, the fixation mechanism 30, and the photographing device. The second shaft arm 242 can be connected to the second motor 244 and the photographing device. When the gimbal 20 is in the folded state and the intermediate state, the first shaft arm 222 can be folded. The photographing device can be at least partially located in the accommodation groove 12. The accommodation groove 12 can restrict the photographing device from rotating in the circumferential direction of the handle 10. When the gimbal 20 is in the unfolded state, the first shaft arm 222 can be unfolded, and the photographing device can be located outside the accommodation groove 12. In some embodiments, the photographing device can be a camera.

In summary, in the handheld gimbal 100 of embodiments of the present disclosure, the motors of the at least two shaft assemblies can be stacked one over another along the same straight line Z in the folded state. Thus, the space occupied by the handheld gimbal 100 in the folded state can be small, and the handheld gimbal 100 can be easy to be stored and transported, which improves the user experience.

In some embodiments, the handheld gimbal 100 can include the handle 10 and the gimbal 20. The gimbal 20 can be connected to the handle 10. The gimbal 20 can include the at least two shaft assemblies. The at least two shaft assemblies can be rotatably connected. A shaft assembly can include a motor. The motors of the at least two shaft assemblies can include motor rotation shafts. The gimbal 20 can be switched between the folded state and the unfolded state. In the folded state, the axes of the motor rotation shafts of the at least two shaft assemblies can be parallel to each other.

In some embodiments, the handheld gimbal 100 of embodiments of the present disclosure can have a substantially same structure as the handheld gimbal above. A difference between the handheld gimbals can include that when the handheld gimbal 100 of embodiments of the present disclosure is in the folded state, the motors of the at least two shaft assemblies cannot be stacked one over another along the same straight line, but the axes of the motor rotation shafts of the at least two shaft assemblies can be maintained to be parallel to each other. When the handheld gimbal 100 of embodiments of the present disclosure is in the folded state, projections of the motors of the at least two shaft assemblies can partially overlap with each other or cannot overlap with each other.

The remaining structure of the handheld gimbal 100 of embodiments of the present disclosure can be the same as the structure of the handheld gimbal above, which is not repeated here.

In summary, in the handheld gimbal 100 of embodiments of the present disclosure, the axes of the motor rotation shafts of the at least two shaft assemblies can be parallel to each other in the folded state. Thus, the space occupied by the handheld gimbal 100 can be small, and the handheld gimbal 100 can be easy to be stored and transported, which improves the user experience.

In some embodiments, the gimbal 20 can include three shaft assemblies. The three shaft assemblies can be rotatably connected. A shaft assembly can include a motor. The motors of the three shaft assemblies can include the motor rotation shafts. In the folded state, the axes of the motor rotation shafts of the three shaft assemblies can be parallel to each other. Thus, the space occupied by the handheld gimbal 100 can be small in the folded state, and the handheld gimbal can be easy to be stored and transported, which improves the user experience.

In some embodiments, the handheld gimbal 100 can include the handle 10 and the gimbal 20. The gimbal 20 can be connected to the handle 10. The gimbal 20 can include at least two shaft assemblies. The at least two shaft assemblies can be rotatably connected. A shaft assembly can include a motor and a shaft arm connected to the motor. The gimbal 20 can be switched between the folded state and the unfolded state. When the gimbal 20 is in the folded state, the shaft arms of the at least two shaft assemblies can be located on the same side of the handle and locked together.

Thus, in the folded state, the shaft arms of the at least two shaft assemblies can be located on the same side of the handle and locked together. The space occupied by the handheld gimbal can be small in the folded state, and the handheld gimbal can be easy to be stored and transported, which improves the user experience. In some embodiments, the motors of the at least two shaft assemblies can be stacked one over another along the same straight line or cannot be stacked one over another along the same straight line. For example, the motors can be staggered from each other or partially stacked, which is not limited here.

In some embodiments, the folding structure of the present disclosure is not limited to be applied to the handheld gimbal 100. The folding structure can include a support member 10 and a rotation member 20. The rotation member 20 can be connected to the support member 10. The rotation member 20 can include at least two shaft assemblies. The at least two shaft assemblies can be rotatably connected. A shaft assembly can include a motor. The motors of the at least two shaft assemblies can include the motor rotation shafts. The rotation member 20 can be switched between the folded state and the unfolded state. In the folded state, the axes of the motor rotation shafts of the at least two shaft assemblies can be parallel to each other. The support member 10 can include a support structure configured to support the rotation member 20, for example, a handle, a bracket, and a base. The rotation member 20 can be a rotation structure that can rotate, for example, a gimbal and a motor group.

Thus, in the folded state, the axes of the motor rotation shafts of the at least two shaft assemblies can be parallel to each other. Thus, the space occupied by the folding structure can be small in the folded state, and the folding structure can be easy to be stored and transported, which improves the user experience.

In some embodiments, the folding structure can include the support member 10 and the rotation member 20. The rotation member 20 can be connected to the support member 10. The rotation member 20 can include the at least two shaft assemblies. The at least two shaft assemblies can be rotatably connected. A shaft assembly can include a motor. The rotation member can be switched between the folded state and the unfolded state. In the folded state, the motors of the at least two shaft assemblies can be stacked one over another along the same straight line. In the unfolded state, the motors of the at least two shaft assemblies can be arranged separately.

Thus, in the folded state, the motors of the at least two shaft assemblies can be stacked one over another along the same straight line. Thus, the space occupied by the folding structure can be small in the folded state, and the folding structure can be easy to be stored and transported, which improves the user experience.

In some embodiments, the folding structure can include the support member 10 and the rotation member 20. The rotation member 20 can be connected to the support member 10. The rotation member 20 can include the at least two shaft assemblies. The at least two shaft assemblies can be rotatably connected. A shaft assembly can include a motor and a shaft arm connected to the motor. The rotation member 20 can be switched between the folded state and the unfolded state. When the rotation member 20 is in the folded state, the shaft arms of the at least two shaft assemblies can be located on the same side of the support member 10 and locked together.

Thus, in the folded state, the shaft arms of the at least two shaft assemblies can be located on the same side of the support member 10 and locked together. Thus, the space occupied by the folding structure can be small in the folded state, and the folding structure can be easy to be stored and transported, which improves the user experience.

In embodiments of the present disclosure, unless otherwise specified and defined, a first feature being “above” or “below” a second feature may include the direct contact of the first and second features, or may include indirect contact of the first and second features through other feature contacts therebetween. Moreover, the first feature being “above,” “on,” and “over” the second feature includes that the first feature is directly above or obliquely above the second feature, or simply means that the first feature is higher in level than the second feature. The first feature being “below,” “under,” and “beneath” the second feature includes that the first feature is directly under or obliquely under the second feature, or simply means that the first feature is lower in height than the second feature.

The present disclosure provides many various implementations or examples to implement different structures of embodiments of the present disclosure. To simplify embodiments of the present disclosure, components, and settings of specific examples are described below. The description is merely exemplary and does not intend to limit embodiments of the present disclosure. Reference numerals and/or letters are repeated in different examples in embodiments of the present disclosure for simplicity and clarity, and does not indicate a relationship among various implementations and/or settings. Embodiments of the present disclosure provide examples of various specific processes and materials, but those of ordinary skill in the art may be aware of the application of other processes and/or use of other materials.

In the description of this specification, referring to the terms “one embodiment,” “some embodiments,” “exemplary embodiments,” “examples,” “specific examples,” or “some examples,” the description means that specific features, structures, materials, or characteristics described in connection with embodiments or examples are included in at least one embodiment or example of the present disclosure. In this specification, the schematic description of the above terms does not necessarily refer to a same embodiment or example. The described specific features, structures, materials, or characteristics may be combined in any suitable manner in any one or more embodiments or examples.

Although embodiments of the present disclosure are described and shown, those of ordinary skill in the art should understand that various changes, modifications, replacements, and variations can be made to embodiments of the present disclosure without departing from the principle and spirit of the present disclosure. These changes, modifications, replacements, and variations should be within the scope of the present disclosure. The scope of the present invention is defined by the claims and equivalents of the claims.

What is claimed is:

1. A handheld gimbal comprising:
a handle; and
a gimbal connected to the handle and including:
at least two shaft assemblies rotatably connected to each other, wherein:
each of the at least two shaft assemblies includes a motor;
the motors of the at least two shaft assemblies are arranged one over another along a same straight line when the gimbal is in a folded state; and
the motors of the at least two shaft assemblies are arranged separately when the gimbal is in an unfolded state.

2. The handheld gimbal according to claim 1, wherein:
in the folded state, axes of motor rotation shafts of the at least two shaft assemblies coincide with the same straight line.

3. The handheld gimbal according to claim 1, wherein the at least two shaft assemblies include:
a first shaft assembly including:
a shaft arm that is able to be folded and unfolded; and
a first motor arranged at a top of the handle; and
a second shaft assembly including a second motor; wherein:
the shaft arm is connected to the first motor and the second motor;
when the gimbal is in the folded state, the shaft arm is folded; and
when the gimbal is in the unfolded state, the shaft arm is unfolded.

4. The handheld gimbal according to claim 3, wherein when the gimbal is in the folded state, the handheld gimbal has one of the following structures that:
a stator of the second motor, a rotor of the second motor, a stator of the first motor, and a rotor of the first motor are arranged one over another along the same straight line;
the rotor of the second motor, the stator of the second motor, the stator of the first motor, and the rotor of the first motor are arranged one over another along the same straight line;
the stator of the second motor, the rotor of the second motor, the rotor of the first motor, and the stator of the first motor are arranged one over another along the same straight line; or
the rotor of the second motor, the stator of the second motor, the rotor of the first motor, and the stator of the first motor are arranged one over another along the same straight line.

5. The handheld gimbal according to claim 3, wherein the shaft arm includes:
a first sub-arm connected to the first motor;
a second sub-arm connected to the second motor; and
a rotation shaft assembly configured to be connected to the first sub-arm and the second sub-arm to be hinged to the first motor and the second motor.

6. The handheld gimbal according to claim 5, wherein the rotation shaft assembly includes:
a lock mechanism arranged between the first sub-arm and the second sub-arm and configured to lock a relative rotation between the first sub-arm and the second sub-arm to lock the gimbal in the unfolded state or the folded state; and
a rotation shaft passing through at least one of the first sub-arm or the second sub-arm to be hinged to the first motor and the second motor.

7. The handheld gimbal according to claim 5, wherein:
one of the first sub-arm and the second sub-arm is curved and another one of the first sub-arm and the second sub-arm is straight, or both the first sub-arm and the second sub-arm are curved; and
when the gimbal is in the folded state, an accommodation space is formed between the first sub-arm and the second sub-arm, and a stator or a rotor of the second motor is located in the accommodation space.

8. The handheld gimbal according to claim 1, wherein:
each of the at least two shaft assemblies includes a shaft arm connected to the motor of the shaft assembly; and
when the gimbal is in the folded state, the shaft arms of the at least two shaft assemblies are located on a same side of the handle and are locked together with each other.

9. The handheld gimbal according to claim 8, wherein:
when the gimbal is in an intermediate state between the folded state and the unfolded state, the shaft arms of the at least two shaft assemblies are located on two opposite sides of the handle.

10. The handheld gimbal according to claim 9, wherein:
the at least two shaft assemblies include:
a first shaft assembly including:
a first shaft arm that is able to be folded and unfolded; and
a first motor arranged at a top of the handle;
a second shaft assembly including a second shaft arm and a second motor; and
a third shaft assembly including a third motor;
the first shaft arm is connected to the first motor and the second motor, and the second shaft arm is connected to the second motor and the third motor;
an accommodation groove is formed on a side of the handle;
when the gimbal is in the folded state or the intermediate state, the first shaft arm is folded, and the third motor is at least partially located in the accommodation groove; and
when the gimbal is in the unfolded state, the first shaft arm is unfolded, and the third motor is located outside the accommodation groove.

11. The handheld gimbal according to claim 10, wherein:
when the gimbal is in the folded state or the intermediate state, the accommodation groove restricts the third motor from rotating along a circumferential direction of the handle.

12. The handheld gimbal according to claim 10, wherein:
at least one of the first motor or the second motor rotates to cause the first shaft arm and the second shaft arm to be switched between being located on a same side of the handle and being located on opposite sides of the handle.

13. The handheld gimbal according to claim 10, wherein:
the first shaft arm includes a sub-arm connected to the second motor;
when the gimbal is in the intermediate state, an unfolding direction of the sub-arm is same as an unfolding direction of the second shaft arm; and
when the gimbal is in the folded state, the unfolding direction of the sub-arm is opposite to the unfolding direction of the second shaft arm.

14. The handheld gimbal according to claim 10, wherein:
when the gimbal is in the intermediate state, the first shaft arm is rotated around the first motor rotation shaft for more than 90° to limit the second shaft arm from being unfolded.

15. The handheld gimbal according to claim 10, further comprising:
a load connector connected to the third motor.

16. The handheld gimbal according to claim 15, wherein the load connector includes a magnet member or a clamp member.

17. The handheld gimbal according to claim 15, wherein:
when the gimbal is in the folded state or the intermediate state, the first shaft arm is folded, and the load connector is at least partially located in the accommodation groove.

18. The handheld gimbal according to claim 10, further comprising:
a photographing device connected to the third motor;
wherein when the gimbal is in the folded state or the intermediate state, the first shaft arm is folded, and the photographing device is at least partially located in the accommodation groove.

19. A handheld gimbal comprising:
a handle; and
a gimbal connected to the handle and including:
at least two shaft assemblies rotatably connected to each other, wherein:
each of the at least two shaft assemblies includes a motor including a motor rotation shaft; and
when the gimbal is in a folded state, axes of the motor rotation shafts of the at least two shaft assemblies are parallel to each other.

20. A handheld gimbal comprising:
a handle; and
a gimbal connected to the handle and including:
at least two shaft assemblies rotatably connected to each other, wherein:
each of the at least two shaft assemblies includes a motor and a shaft arm connected to the motor;
when the gimbal is in a folded state, the shaft arms of the at least two shaft assemblies are located on a same side of the handle and locked together with each other.
